(19) United States
(12) Patent Application Publication
(10) Pub. No.: US 2010/0149622 A1
(43) Pub. Date: Jun. 17, 2010

(54) DIGITAL MICRO-MIRROR DEVICE

(75) Inventors: Gregory John McAvoy, Balmain (AU); Ronan Padraig Sean O'Reilly, Balmain (AU); Vincent Patrick Lawlor, Balmain (AU); Kia Silverbrook, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 12/336,529

(22) Filed: Dec. 17, 2008

(51) Int. Cl. G02B 26/02

(52) U.S. Cl. 359/291; 359/221.2

(57) ABSTRACT

A digital micro-mirror device comprising an array of micro-mirror assemblies positioned on a substrate. Each micro-mirror assembly comprises: a mirror spaced apart from the substrate; a stem supporting the mirror; and first and second electrodes positioned on either side of the stem. The stem is comprised of a resiliently flexible material, such that the mirror can tilt either towards the first electrode or towards the second electrode by an electrostatic force. The digital micro-mirror device may be used in data projectors and the like.

### FIELD OF THE INVENTION

The present invention relates to a digital mirror device (DMD). It has been developed primarily to provide an improved device, which may be fabricated using straightforward MEMS fabrication steps.

### CO-PENDING APPLICATIONS

The following application has been filed by the Applicant simultaneously with the present application:
MMJ009US

The disclosure of this co-pending application is incorporated herein by reference. The above application has been identified by its filing docket number, which will be substituted with the corresponding application number, once assigned.

### CROSS REFERENCES

The following patents or patent applications filed by the applicant or assignee of the present invention are hereby incorporated by cross-reference.

| | | | | |
|---|---|---|---|---|
| 12/142,779 | 11/763,440 | 12/114,826 | 11/685,084 | 11/740,925 |
| 11/763,443 | 11/946,840 | 12/323,471 | 6,799,853 | |

### BACKGROUND OF THE INVENTION

Digital micromirror devices (DMDs) are now relatively commonplace in a plethora of optical devices, such as data projectors. In such devices, an image is created by microscopically small mirrors laid out in a matrix on a semiconductor chip (DMD). Each mirror represents one or more pixels in the projected image. The number of mirrors corresponds to the resolution of the projected image.

DMD technology was developed by Texas Instruments in the 1980s (see, for example, U.S. Pat. No. 4,956,619; U.S. Pat. No. 4,662,746 and related patents).

A DMD chip has on its surface several hundred thousand microscopic mirrors arranged in a rectangular array which correspond to the pixels in the image to be displayed. The mirrors can be individually rotated ±10-12°, to an on or off state. In the on state, light from the projector bulb is reflected into a lens making the pixel appear bright on the screen. In the off state, the light is directed elsewhere (usually onto a heatsink), making the pixel appear dark.

To produce grayscales, the mirror is toggled on and off very quickly, and the ratio of on time to off time determines the shade produced (binary pulse-width modulation). Contemporary DMD chips can produce up to 1024 shades of gray.

The mirrors themselves are made out of aluminium and are usually around 16 micrometres square. Each mirror is mounted on a yoke via a rigid stem extending from a lower surface of the mirror. The yoke is supported by a compliant torsion hinge, which allows movement of the yoke (and thereby the mirror) between its on and off positions. The torsion hinges are relatively resistant to fatigue and vibration shock.

Electrodes control the position of the mirror by electrostatic attraction/repulsion. A pair of electrodes is positioned on each side of the hinge, one acting on the yoke and the other acting directly on the aluminium mirror. A bias potential of about 20-30 volts is applied to the mirror and yoke, whilst the electrodes are addressed using 5 volt CMOS. Hence, when the electrodes on one side to the mirror are driven to +5V, the mirror tilts towards the opposite side where the electrodes are at 0V. Reversing the CMOS voltages causes the mirror to tilt the other way. Accordingly, the on/off state of each mirror is controllable via the CMOS.

For a more detailed explanation of DMDs, such as those described above, reference is made to David Armitage et al, Introduction to Microdisplays, John Wiley and Sons, 2006.

The design of DMDs had been relatively unchanged for the past decade or so. However, their relatively complex design, with several moving parts in each mirror assembly, requires a correspondingly complex MEMS fabrication process. This complexity increases fabrication costs and potentially impacts on the extent to which each mirror assembly can be miniaturized. It would be desirable to provide a DMD, which has a relatively simple design compared to known DMDs.

### SUMMARY OF THE INVENTION

In a first aspect, there is provided a digital micro-mirror device comprising an array of micro-mirror assemblies positioned on a substrate, each micro-mirror assembly comprising:

a mirror spaced apart from the substrate, the mirror having an upper reflective surface and a lower support surface;

a stem supporting the mirror, the stem extending from the substrate to the lower support surface, the stem defining a tilt axis for the mirror;

a first electrode and a second electrode, the first and second electrodes being positioned on either side of the stem, each electrode being individually addressable via electronic circuitry in the substrate,

wherein the stem is comprised of a resiliently flexible material, such that the mirror can tilt either towards the first electrode or towards the second electrode by an electrostatic force.

Since the mirror tilts about the flexible stem, the present invention obviates the yoke and torsion hinge arrangement in convention DMDs. This vastly simplifies the overall design of the DMD, as well as its fabrication.

Optionally, the stem is comprised of a polymer, such as polydimethylsiloxane (PDMS). PDMS has a relatively low Young's modulus (less than 1000 MPa) enabling the stem to be bent by electrostatic forces applied via the electrode(s). Moreover, the Applicant has previously demonstrated the utility of PDMS in MEMS devices, and its facile incorporation into MEMS fabrication processes.

Optionally, a whole extent of the upper reflective surface is planar. This is in contrast with prior art DMDs, where there is a central dimple in the upper reflective surface resulting from a join with the stem. A fully planar upper reflective surface advantageously improves optical quality compared with prior art devices.

Optionally, the mirror comprises a metal plate, the metal plate defining the upper reflective surface. Optionally, the metal plate is an aluminium plate.

Optionally, the mirror further comprises a support platform for the metal plate, the support platform defining the lower support surface. Hence, the mirror is typically an integrated two-part construction comprising an upper metal plate and lower support platform for the metal plate.

Optionally, the support platform is substantially coextensive with the metal plate.

Optionally, the support platform and the stem are comprised of the same material. Typically, the stem and support platform are co-formed in a single deposition step. For example, deposition of PDMS may co-form the stem and support platform.

Optionally, the first and second electrodes define first and second landing pads for the mirror.

Optionally, the mirror has first and second contact points for contacting respective first and second landing pads, and wherein the first and second contact points are comprised of a polymer. Since the contact points are comprised of a polymer (e.g. PDMS), the tendency for the mirror to become stuck on the either electrode is minimized.

Optionally, the support platform defines the first and second contact points. Hence, no additional features are required to address potential stiction problems. The support platform performs the dual functions of supporting an upper aluminium reflective plate and minimizing stiction between the mirror and the electrodes.

Optionally, the mirror is electrically connected to a biasing potential. The biasing potential typically maintains the mirror at a high potential so that the mirror is tiltable via electrodes controlled by CMOS voltages (usually 5V).

The stem may be comprised of a conducting polymer, so that the stem provides electrical connection to the biasing potential. For example, the stem may be comprised of PDMS implanted with metal ions.

Alternatively, a plurality of mirrors may be coupled together in rows, with each row being electrically connected at one end to the biasing potential. Hence, the biasing potential may be applied to a whole row of mirrors via a common contact.

Optionally, each row of mirrors has a common tilt axis.

Optionally, adjacent mirrors in a row are coupled together via a linkage, the linkage being aligned along the common tilt axis.

Optionally, the substrate is a silicon substrate including one or more CMOS layers, the CMOS layers comprising the electronic circuitry.

In a second aspect, there is provided a projector comprising the digital mirror device as described above. Projectors and projector systems employing DMDs will be well-known to the skilled person.

In a third aspect, there is provided, a method of fabricating a micro-mirror assembly, the method comprising the steps of:

(a) forming a pair of electrodes spaced apart on a surface of a substrate, the electrodes being connected to underlying electronic circuitry in the substrate;

(b) depositing a layer of sacrificial material over the electrodes and the substrate;

(c) defining a stem opening in the sacrificial material so as to form a scaffold, the stem opening being positioned between the electrodes;

(d) depositing a layer of resiliently flexible material over the scaffold;

(e) depositing a metal layer over the flexible layer;

(f) etching through the metal layer and the flexible layer to define an individual micro-mirror supported on a stem of flexible material, the micro-mirror comprising a metal layer fused to a support platform; and

(g) removing the sacrificial material to provide the micro-mirror assembly.

The method according to the third aspect provides a simple and effective means of fabricating DMDs, using a minimal number of fabrication steps.

Optionally, the resiliently flexible material is comprised of polydimethylsiloxane (PDMS).

Optionally, the sacrificial material is photoresist.

Optionally, the metal layer is comprised of aluminium.

Optionally, an array of micro-mirrors are fabricated simultaneously on the substrate, the array defining a digital micro-mirror device.

Optionally, the substrate is a silicon substrate including one or more CMOS layers, the CMOS layers comprising the electronic circuitry.

In a fourth aspect, there is provided a micro-mirror assembly comprising a tiltable mirror supported by a stem, wherein the stem is comprised of a resiliently flexible material.

Optionally, the tiltable mirror comprises a metal layer having an upper reflective surface.

Optionally, the tiltable mirror further comprises a support platform onto which the metal layer is mounted, the support platform being comprised of the resiliently flexible material.

Optionally, the resiliently flexible material is comprised of polydimethylsiloxane (PDMS).

Optionally, the mirror is tiltable by an electrostatic force.

Optionally, a pair of electrodes are positioned on either side of the stem, the electrodes providing, at least part of the electrostatic force.

### BRIEF DESCRIPTION OF THE DRAWINGS

An optional embodiment of the present invention will now be described by way of example only with reference to the accompanying drawings, in which:

FIG. 1 is schematic sectional view of a DMD according to the present invention;

FIG. 2 is the DMD of FIG. 1 in a tilted position;

FIG. 3 is a plan of the DMD shown in FIG. 1;

FIG. 4 shows a first stage of MEMS fabrication in which electrodes are formed;

FIG. 5 shows a second stage of MEMS fabrication in which a sacrificial scaffold is formed;

FIG. 6 shows a third stage of MEMS fabrication in which mirror layers and a stem are deposited;

FIG. 7 shows a fourth stage of MEMS fabrication in which individual micro-mirrors are defined; and

FIG. 8 shows a data projector employing a DMD according to the present invention.

### DETAILED DESCRIPTION OF THE INVENTION

The present Applicant has previously demonstrated the versatility of polydimethylsiloxane (PDMS) in MEMS devices (see, for example, U.S. application Ser. No. 12/142,779 filed Jun. 20, 2008 and U.S. application Ser. No. 11/685,084 filed Mar. 12, 2007, the contents of each of which are herein incorporated reference). In particular, the incorporation of PDMS into conventional MEMS fabrication processes has led to improvements in mechanical inkjet devices, as well as opening up a new field of lab-on-a-chip devices and microanalysis systems.

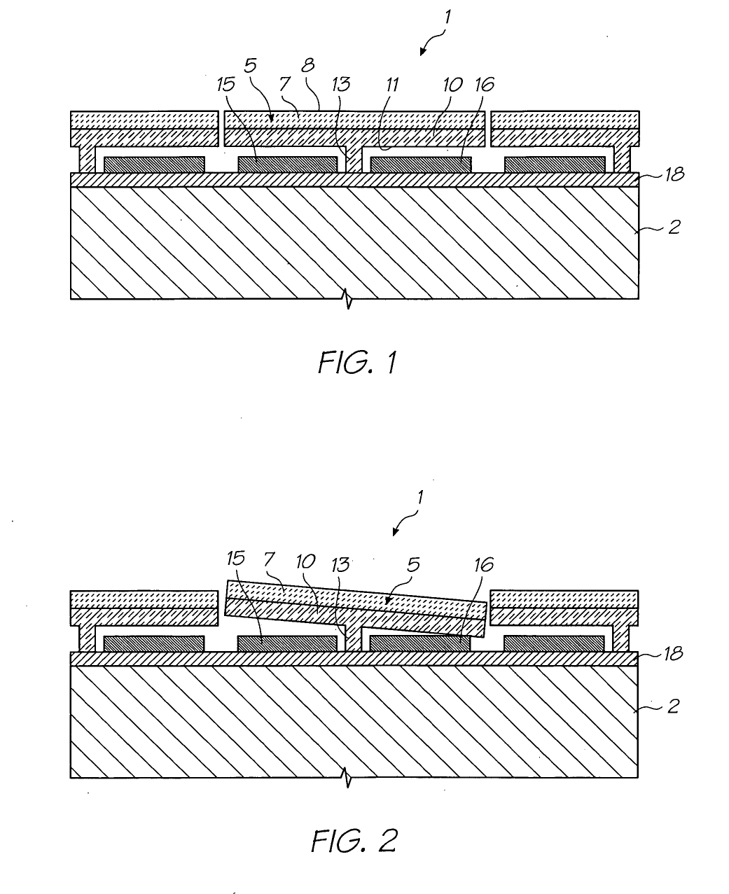

It has now been found that PDMS has properties suitable for use in DMDs, which may consequently have a much simpler design than commercially available DMDs. Referring to FIGS. 1 and 2, there is shown part of a digital micro-mirror device according to the present invention. The DMD comprises a plurality of micro-mirror assemblies 1 arranged in a matrix on a surface of a substrate 2. Typically, each micro-mirror assembly 1 is separated from adjacent micro-mirror assemblies by less than 5 microns (e.g. 2 microns). The micro-mirror assembly comprises a mirror 5, which is spaced apart from the substrate 1. Each mirror is typically square and has a length of in the range of about 10 to 20 microns.

The mirror 5 comprises an aluminium plate 7, which defines an upper reflective surface 8 of the mirror. The mirror 5 further comprises a support platform 10, which defines a lower support surface 11 of the mirror. The aluminium plate 7 is fused to the support platform 10 during MEMS fabrication of the DMD. By virtue of the aluminium plate 7 being mounted on the support platform 10, the upper reflective surface 8 of the mirror 5 can be made planar across its entire extent. This advantageously provides excellent optical definition. By contrast, prior art DMDs typically have an indentation in the reflective surface where a support post is joined to the mirror.

Although aluminium is the reflective material typically used in DMDs, it will be appreciated that other metals (e.g. titanium) may be used instead.

The mirror 5 is supported by a resiliently flexible stem 13, which extends from the substrate 2 to the lower support surface 11. Both the stem 13 and the support platform 10 form an integrated structure comprised of the same flexible material. Typically, the stem 13 and support platform 10 are comprised of a polymer having a Young's modulus of less than 1000 MPa. A preferred material for forming the stem 13 is polydimethylsiloxane, which has a Young's modulus of about 600 MPa.

The stem 13 defines a tilt axis for the mirror 5. As can be seen most clearly in FIG. 2, the mirror 5 is able to tilt about the tilt axis at angles of up to about ±15 degrees, typically ±7 to 10 degrees. The resiliently flexible stem 13 should be contrasted with prior art DMDs, whereby a rigid stem is hinged at its base to allow tilting of the mirror.

The stem 13 may be in the form of a support post attached to a centroid of the mirror 5. Alternatively, the stem 13 may extend at least partially along the tilt axis. Typically, the stem 13 takes the form of a supporting wall extending along the tilt axis, and co-extensive with the mirror

A first electrode 15 and a second electrode 16 are positioned on either side of the stem 13. The first and second electrodes are individually addressable by electronic circuitry in the silicon substrate 1, which enables the mirror 5 to tilt by electrostatic attraction. A typical operation of the DMD will be described in more detail below. The electronic circuitry is contained in CMOS layers 18, which are included in an upper part of the substrate.

As shown most clearly in FIG. 2, the first and second electrodes define landing pads for the mirror 5 when it is tilted. One of the problems of prior art DMDs is stiction forces between the mirror/yoke and the landing pads. Stiction forces may cause the mirror to become permanently stuck to one landing pad, resulting in a mirror becoming non-operational. However, in the micro-mirror assembly 1, the support platform 10 defines first and second contact points for contacting the landing pads. Since the support platform 10 is advantageously comprised of PDMS, any stiction forces are minimal.

In keeping with prior art DMDs, the DMD of the present invention functions most effectively if the mirror 5 is maintained at a relatively high potential (e.g. 20 to 50 volts) by a biasing potential. This maximizes the requisite electrostatic forces when either the first or second electrodes are switched on or off by the underlying 5 volt CMOS circuitry.

The biasing potential may be applied to the aluminium plate 7 via the support stem 13. Although polymeric materials such as PDMS are usually electrically-insulating, it is possible to make such materials conductive by implanting metal ions, such as titanium ions (see, for example, Dubois et al, Sensors and Actuators A, 130-131 (2006), 147-154, the contents of which is herein incorporated by reference). Hence, with an electrically conducting stem 13, the aluminium plate 7 may be held at a high biasing potential.

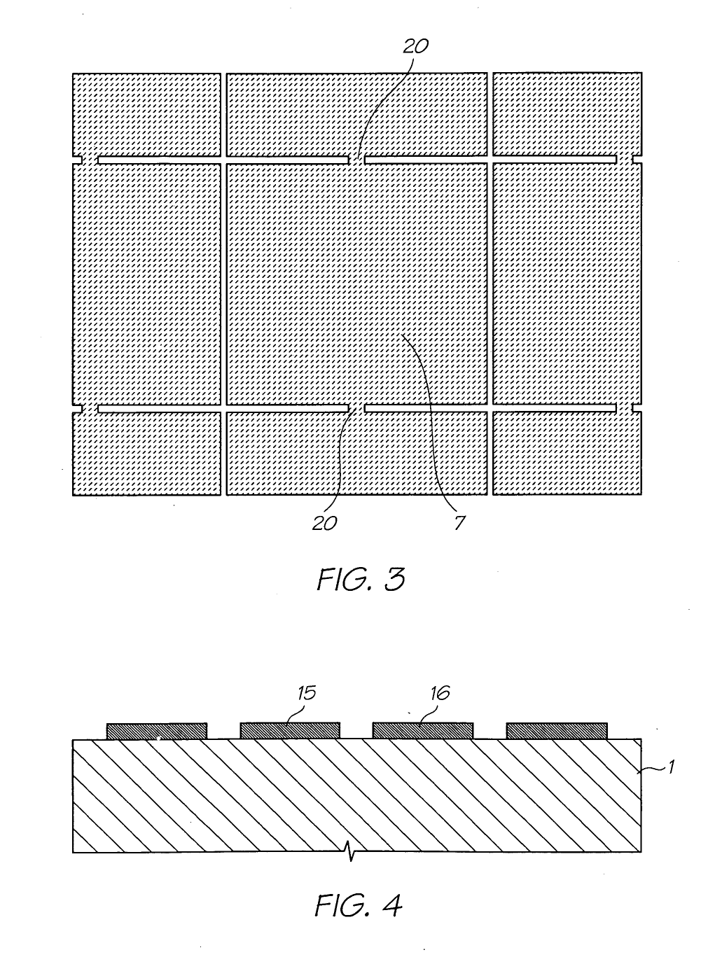

Alternatively, the biasing potential may be applied to the aluminium plate 7 by coupling the plates together, as shown in FIG. 3, and applying the biasing potential to a row of mirrors from a voltage source at one end of the row. Adjacent plates 7 are daisy-chained together via linkages 20 extending along the tilt axis of the mirrors. The linkages are positioned along the tilt axis so as to minimize their impedance to mirror tilting.

Although the linkages 20 inevitably experience a small torsional force during mirror tilting, these linkages generally do not fatigue from this torsional force. This is due to the microscopic scale of the coupling members, which allows immediate relief of any crystal dislocations. The torsional hinges in traditional DMDs do not fatigue for the same reason.

Referring now to FIG. 2, there is shown a micro-mirror assembly 1 in a tilted position. In order to move to the tilted position shown, the first electrode 15 is set to +5V and the second electrode is set to 0V by the CMOS circuitry 18. Since the aluminium plate is biased to a potential of about +45V, the mirror 5 experiences an electrostatic repulsion force from the first electrode and tilts towards the second electrode. Of course, reversal of the electrode polarities will cause the mirror 5 to tilt in the opposite direction. In order to maintain the mirror 5 in its tilted position, then both electrodes may be set to +5V or 0V.

It will be appreciated that, during tilting, the stem 13 flexes to accommodate the tilt of the mirror 5. Hence, unlike prior art designs, there is no requirement for any intricate torsional hinge arrangements, to allow resilient tilting of the mirror.

Referring now to FIGS. 4 to 7, there is shown a simplified MEMS fabrication process for fabricating the DMD shown in FIG. 1. In FIGS. 4 to 7, the CMOS layers 18 are not shown.

In a first step shown in FIG. 4, the electrodes (or landing pads) are formed by a depositing 1 micron layer of aluminum onto the CMOS substrate 1, and etching to define the individual first and second electrodes 15 and 16. The aluminium electrodes connect with an upper metal layer in the underlying CMOS so that each electrode is individually controllable.

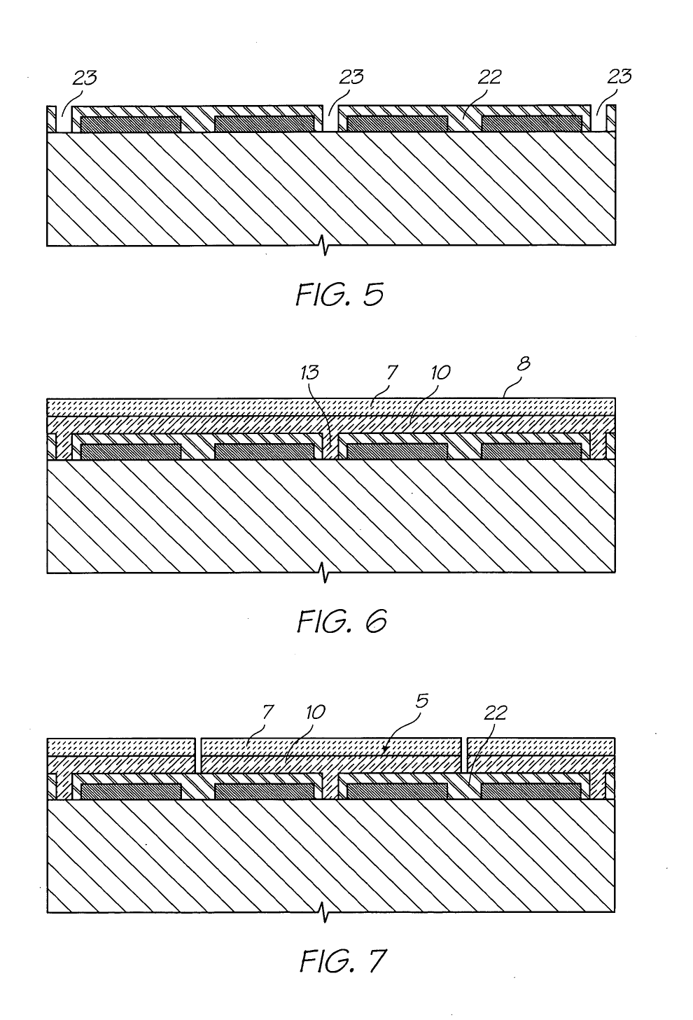

In a second step shown in FIG. 5, a layer of photoresist 22 is spun onto the electrodes and patterned to define stem openings 23. This layer of photoresist 22 functions as a sacrificial scaffold for subsequent deposition of PDMS and aluminium.

In a third step shown in FIG. 6, a PDMS layer is deposited onto the photoresist layer 22 followed by deposition of an aluminium layer. The PDMS layer comprises the stems 13 and support platforms of 10 of each micro-mirror assembly. The aluminium layer comprises the plates 7 having the upper reflective surfaces 8.

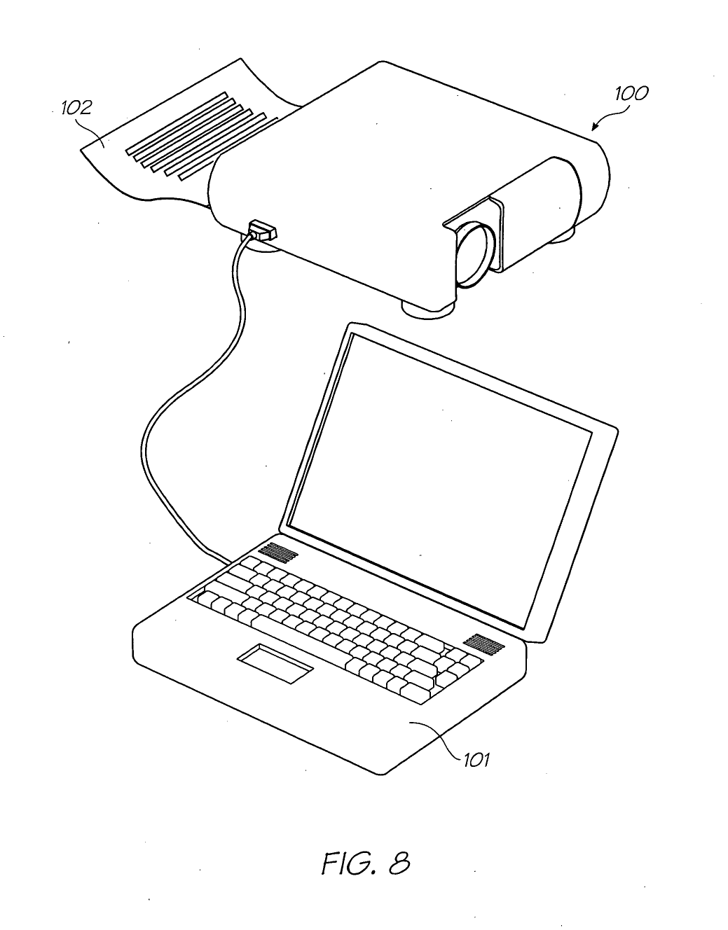

In a fourth step shown in FIG. 7, the PDMS and aluminium layers are etched to define individual mirrors 5. This etch step uses a suitably patterned photoresist mask (not shown) and may require different etch chemistries for etching through the different layers.

In a final step, the sacrificial photoresist 22 is removed by exposing to an oxidizing plasma (e.g. O₂ plasma). The final ‘ashing’ step provides the DMD shown in FIG. 1.

FIG. 8 shows a typical data projector 100 (e.g. image projector or video projector) employing a DMD as described above. Any data projector incorporating a known DMD may, alternatively, incorporate the DMD according to the present invention. As described in U.S. Pat. No. 6,966,659, the contents of which is herein incorporated by reference, the projector may additionally comprise a printhead for printing images received from a computer system 101. For example, printouts 102 may be ejected from a rear of the projector 100 as shown in FIG. 8.

It will, of course, be appreciated that the present invention has been described by way of example only and that modifications of detail may be made within the scope of the invention, which is defined in the accompanying claims.

1. A digital micro-mirror device comprising an array of micro-mirror assemblies positioned on a substrate, each micro-mirror assembly comprising:
a mirror spaced apart from the substrate, said mirror having an upper reflective surface and a lower support surface;
a stem supporting said mirror, said stem extending from said substrate to said lower support surface, said stem defining a tilt axis for said mirror;
a first electrode and a second electrode, said first and second electrodes being positioned on either side of said stem, each electrode being individually addressable via electronic circuitry in said substrate,
wherein said stem is comprised of a resiliently flexible material, such that said mirror can tilt either towards said first electrode or towards said second electrode by an electrostatic force.

2. The digital micro-mirror device of claim 1, wherein said stem is comprised of a polymer.

3. The digital micro-mirror device of claim 1, wherein said stem is comprised of polydimethylsiloxane (PDMS).

4. The digital micro-mirror device of claim 1, wherein a whole extent of said upper reflective surface is planar.

5. The digital micro-mirror device of claim 1, wherein said mirror comprises a metal plate, said metal plate defining said upper reflective surface.

6. The digital micro-mirror device of claim 5, wherein said metal plate is an aluminium plate.

7. The digital micro-mirror device of claim 5, wherein said mirror further comprises a support platform for said metal plate, said support platform defining said lower support surface.

8. The digital micro-mirror device of claim 7, wherein said support platform is substantially coextensive with said metal plate.

9. The digital micro-mirror device of claim 7, wherein said support platform and said stem are comprised of the same material.

10. The digital micro-mirror device of claim 1, wherein said first and second electrodes define first and second landing pads for said mirror.

11. The digital micro-mirror device of claim 10, wherein said mirror has first and second contact points for contacting respective first and second landing pads, and wherein said first and second contact points are comprised of a polymer.

12. The digital micro-mirror device of claim 11, wherein said support platform defines said first and second contact points.

13. The digital micro-mirror device of claim 1, wherein said mirror is electrically connected to a biasing potential.

14. The digital micro-mirror device of claim 13, wherein said stem is comprised of a conducting polymer, said stem providing electrical connection to said biasing potential.

15. The digital micro-mirror device of claim 14, wherein said stem is comprised of polydimethylsiloxane (PDMS) implanted with metal ions.

16. The digital micro-mirror device of claim 13, wherein a plurality of mirrors are coupled together in rows, each row being electrically connected at one end to said biasing potential.

17. The digital micro-mirror device of claim 1, wherein each row of mirrors has a common tilt axis.

18. The digital micro-mirror device of claim 1, wherein adjacent mirrors in a row are coupled together via a linkage, said linkage being aligned along said common tilt axis.

19. The digital micro-mirror device of claim 1, wherein said substrate is a silicon substrate including one or more CMOS layers, said CMOS layers comprising said electronic circuitry.

20. A projector comprising the digital mirror device according to claim 1.
